(19) United States
(12) Patent Application Publication
(10) Pub. No.: US 2008/0218902 A1
(43) Pub. Date: Sep. 11, 2008

(54) METHOD FOR MEASURING WIDTH OF PLATING LAYER, MAGNETIC RECORDING HEAD, AND MANUFACTURING METHOD THEREOF

(75) Inventors: Kazumasa Hosono, Kawasaki (JP); Yukinori Ikegawa, Kawasaki (JP); Masaya Kato, Kawasaki (JP); Masashi Yanagawa, Kawasaki (JP); Kaoru Yamakawa, Kawasaki (JP); Takashi Ito, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/036,716

(22) Filed: Feb. 25, 2008

(30) Foreign Application Priority Data
Mar. 5, 2007 (JP) 2007-053679

(51) Int. Cl. G11B 5/127

(52) U.S. Cl. 360/125.02

(57) ABSTRACT

A magnetic head has a main magnetic pole made of at least a magnetic material and a coil. The main magnetic pole has a stop layer through an inorganic insulating layer on both sides of the main magnetic pole in the widthwise direction. The boundary between the main magnetic pole and the metal layer becomes clear by the intervention of the inorganic insulating layer when viewing the flattened pattern plane by a scanning electron microscope and measuring the width of the main magnetic pole as a core width. The measurement accuracy of the main magnetic pole width can be improved and reductions in manufacturing yield rates which occur due to measurement errors can be prevented.

The present invention relates to a method to measure the width of a plating layer during a step of manufacturing a magnetic head for perpendicular magnetic recording, a magnetic recording head, and a manufacturing method thereof. In particular, the present invention relates to a method to measure the width of a plating layer, a magnetic recording head, and a manufacturing method thereof with a configuration that allows the width of a plating layer which functions as a main magnetic pole to be accurately measured.

### BACKGROUND OF THE INVENTION

Conventionally, a perpendicular magnetic recording method uses a perpendicular magnetic recording head and a perpendicular two layer medium. The two layers are a soft magnetic underlayer and a magnetic recording layer.

A perpendicular magnetic recording head uses a magnetic monopole type head that generates a recording magnetic field in the perpendicular direction. A magnetic monopole type perpendicular magnetic recording head has a main magnetic pole made of a magnetic material, an auxiliary pole made of the same magnetic material, a connection member that magnetically connects the main magnetic pole and the auxiliary pole on the opposite side of the opposing face of a medium, and a coil wound up on the connection member (see patent reference Japanese Patent Application Laid-Open Publication No. 2006-139839 and Japanese Patent Application Laid-Open Publication No. 2006-190397)

In recent years perpendicular magnetic recording heads equipped with trailing shields, which function as return yoke on the trailing edge side of a magnetic monopole type perpendicular magnetic recording head, have been put into practical use. But, a monopole type perpendicular magnetic recording head have a problem that the soft magnetic underlayer is thick.

A perpendicular magnetic recording head equipped with a trailing shield not only generates a magnetic field in the perpendicular direction but also generates a magnetic field in the horizontal direction. In other words, A perpendicular magnetic recording head generates a magnetic field in the oblique direction. The magnetic field in the oblique direction makes it easy to switch recording layers. Reducing the perpendicular magnetic field makes it possible to make the soft magnetic underlayer thinner.

The manufacturing method of a perpendicular magnetic recording head uses a semiconductor manufacturing technology. A perpendicular magnetic recording head is formed after forming a read head on the leading edge side. The manufacturing method of the perpendicular magnetic recording head includes steps of forming a plating layer as a main magnetic pole making of a magnetic material such as CoFe; adhering a metal film, such as Ti, as a stop layer for chemical mechanical polishing (CMP), adhering an inorganic insulating film, such as an aluminum film (Al 2O3), and flattening the main magnetic pole by chemical mechanical polishing (CMP).

A CD type scanning electron microscope (SEM) is used to inspect the patterned surface after chemical mechanical polishing (CMP). In more detail, the width of the main magnetic pole (plating layer), namely the core width, will be measured to verify that it is within the specific allowable error limit for specified dimensions. Several samples of heads formed on wafers are taken and measured when measuring the width of this main magnetic pole. A head is removed as a defective item when outside the allowable error limit.

During this type of width measurement of a conventional main magnetic pole however, it is unclear when the boundary of a metal film adhering to the main magnetic pole (plating layer) as a stop layer can be seen by a scanning electron microscope (SEM). Because of this, it becomes difficult to measure the core width including the width of the metal film. In other words, large measurement errors are a problem.

Therefore, even if the core width is within the allowable error limit, there is still a chance that it will be judged to be outside the allowable error limit. This has a serious impact on the manufacturing yield rate.

The object of the present invention is to provide a method to measure the width of a plating layer, a magnetic recording head, and a manufacturing method thereof that can clarify the boundary between the main magnetic pole and the metal layer and more accurately measure the width of the main magnetic pole.

### SUMMARY OF THE INVENTION

In accordance with an aspect of an embodiment, a magnetic recording head includes a main magnetic pole made of at least a magnetic material and a coil. The main magnetic pole has a stop layer through an inorganic insulating layer on both sides of the main magnetic pole in the widthwise direction.

In addition, in accordance with an aspect of an embodiment, a manufacturing method of a magnetic recording head includes steps of forming a stop layer through a first inorganic insulating layer on a main magnetic pole patterned on a substrate; forming a second inorganic insulating layer on the main magnetic pole, the first inorganic insulating layer, and the stop layer; flattening the second inorganic insulating layer using the stop layer as a stop material; removing the stop layer; and flattening the first inorganic insulating layer and the main magnetic pole.

In addition, in accordance with an aspect of an embodiment, a method for measuring plating width includes steps of: forming an inorganic insulating layer on a side of a patterned plating layer; and measuring the gap of the inorganic insulating layer.

### BRIEF DESCRIPTION OF THE DRAWINGS

The present invention will be explained with reference to the accompanying drawings.

FIG. 1A is a cross-sectional view of a head structure equipped with a perpendicular magnetic recording head of the present invention.

FIG. 1B is a plan view of the head in FIG. 1A viewed from the opposing face of the medium.

FIG. 2 is a descriptive view when a portion of the main magnetic pole of FIGS. 1A and 1B is extracted.

FIG. 3A is an enlarged view of the core portion of the main magnetic pole of FIG. 1A.

FIG. 3B is an enlarged view of the core portion of the main magnetic pole of FIG. 1B.

FIG. 4A is a descriptive view showing the manufacturing step of the main magnetic pole of the perpendicular magnetic recording head according to the manufacturing method of the embodiment.

FIG. 4B is a descriptive view showing the post bake step according to the manufacturing method of the embodiment.

FIG. 4C is a descriptive view showing the magnetic layer plating step according to the manufacturing method of the embodiment.

FIG. 4D is a descriptive view showing the ion milling step according to the manufacturing method of the embodiment.

FIG. 4E is a descriptive view showing the aluminum sputtering step according to the manufacturing method of the embodiment.

FIG. 4F is a descriptive view showing the Ta cap sputtering step according to the manufacturing method of the embodiment.

FIG. 4G is a descriptive view showing the resist patterning step according to the manufacturing method of the embodiment.

FIG. 4H is a descriptive view showing the ion milling step according to the manufacturing method of the embodiment.

FIG. 4I is a descriptive view showing the aluminum overcoat step according to the manufacturing method of the embodiment.

FIG. 4J is a descriptive view showing the flattening step according to the manufacturing method of the embodiment.

FIG. 4K is a descriptive view showing the reactive ion etching step according to the manufacturing method of the embodiment.

FIG. 4L is a descriptive view showing the flattening step according to the manufacturing method of the embodiment.

FIG. 4M is a descriptive view showing the step measuring the core width according to the manufacturing method of the embodiment.

FIG. 5A is a descriptive view of the main magnetic pole structure obtained by the manufacturing method of the embodiment.

FIG. 5B is an image observation of the core width obtained in this embodiment according to a scanning electron microscope.

FIG. 5C is an image observation of the core width obtained in a conventional core structure according to a scanning electron microscope.

FIG. 6A is a descriptive view of a photographic image observation from a scanning electron microscope of the main magnetic pole structure obtained by the manufacturing method of the embodiment.

FIG. 6B is a descriptive view of a photographic image observation from a scanning electron microscope of a conventional main magnetic pole structure.

### DETAILED DESCRIPTION

Hereinafter, the preferred embodiments for implementing a magnetic head in accordance with the present invention will be described.

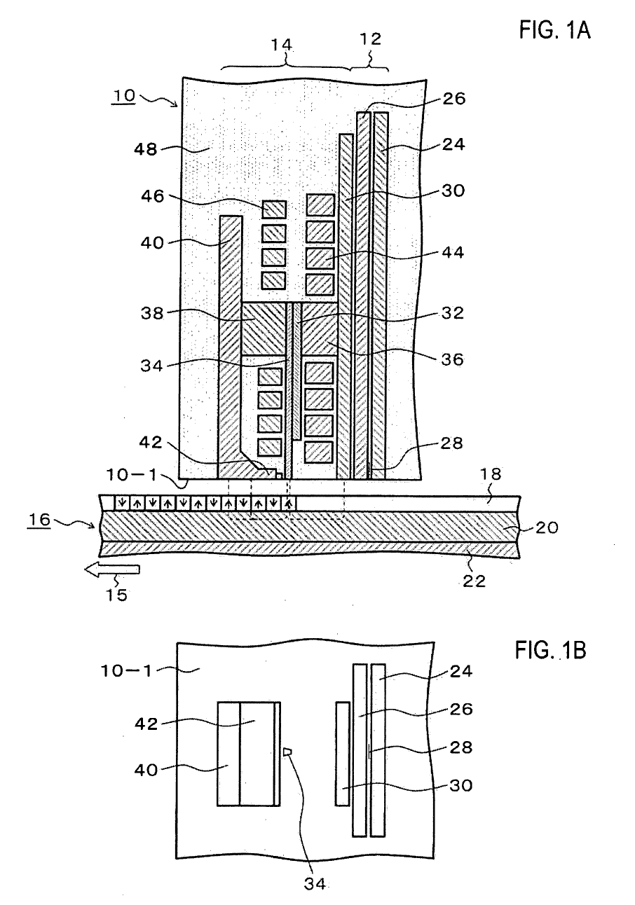

FIG. 1A is a cross-sectional view of a head structure equipped with the perpendicular magnetic recording head of the embodiment. FIG. 1A is a cross-sectional view in perpendicular to film plane and plane on the opposing face of the medium. In FIG. 1A, the head 10 is mounted to the end of a slider provided on the tip of a head actuator of a hard disk drive. The head 10 itself is manufactured using a semiconductor technology. A read head 12 and a perpendicular magnetic recording head 14 are formed on the head 10. The read head 12 is nearer the slider than the perpendicular magnetic recording head 14.

A perpendicular magnetic recording medium 16 is rotated at a fixed speed by a spindle motor and faces to the opposing face of a medium 10-1 of the head 10 through a specified floating distance. The perpendicular magnetic recording medium 16 is comprised by a recording layer 18, a soft magnetic underlayer 20 formed by a soft magnetic material, and a glass substrate 22 and moves in the direction shown by the arrow 15 with respect to the head 10.

A lower shield 24 and an upper shield 26 formed by a magnetic material are provided on the read head 12 of the head 10. A read sensor 28 is arranged on the side of the opposing face of the medium 10-1 between the lower shield 24 and the upper shield 26. A giant magnetoresistance (GMR) effect sensor or a tunnel magnetoresistance (TMR) effect sensor is used for the read sensor 28.

A perpendicular magnetic recording head 14 has a main magnetic pole 34, a main magnetic pole auxiliary layer 32, return yolks 30, 40, connection members 36, 38, and write coils 44, 46. The main magnetic pole 34 is formed by a magnetic material with ferromagnetic such as CoFe. The main magnetic pole auxiliary layer 32 is formed by NiFe integrally provided with the main magnetic pole 34. The return yoke 30, 40 are formed by NiFe arranged as auxiliary poles on both sides of the main magnetic pole 34. The connection members 36, 38 are formed by NiFe that magnetically connect the main magnetic pole 34 and the return yoke 30, 40 on the opposing side of the opposing face of the medium 10-1. The write coils 44, 46 are wound up on the connection members 36, 38.

Furthermore, a trailing shield 42 is arranged on the side of the opposing face of the medium 10-1 of the return yoke 40 arranged on the trailing edge side. The end of the trailing shield 42 is extruded to the main magnetic pole 34.

FIG. 1B shows the side of the opposing face of the medium 10-1 of the head 10. The lower shield 24 and the upper shield 26 are arranged in the read head 12 in FIG. 1B. A read sensor 28 is also arranged between the lower shield 24 and the upper shield 26.

The perpendicular magnetic recording head 14 is adjacent to the read head 12. The main magnetic pole 34 is arranged between the return yoke 30, 40. The trailing shield 42 is integrally provided on the return yoke 40 side.

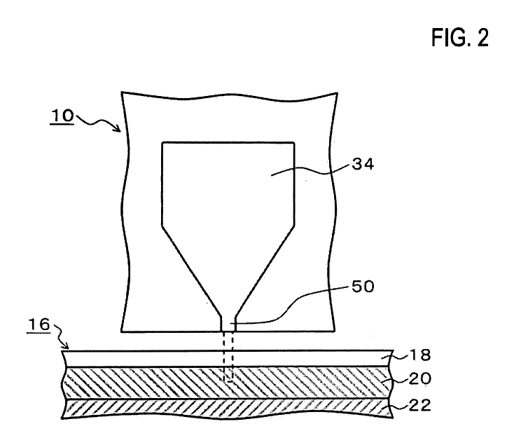

FIG. 2 is a descriptive view when a portion of the main magnetic pole of FIGS. 1A and 1B is extracted and viewed from the end side. The main magnetic pole 34 extends to the lower side while becoming more narrow in width from the portion where the write coils 44, 46 of FIG. 1A are positioned. A core 50 is formed on the opposing face of the medium 10-1, and is narrowed down to a microscopic width.

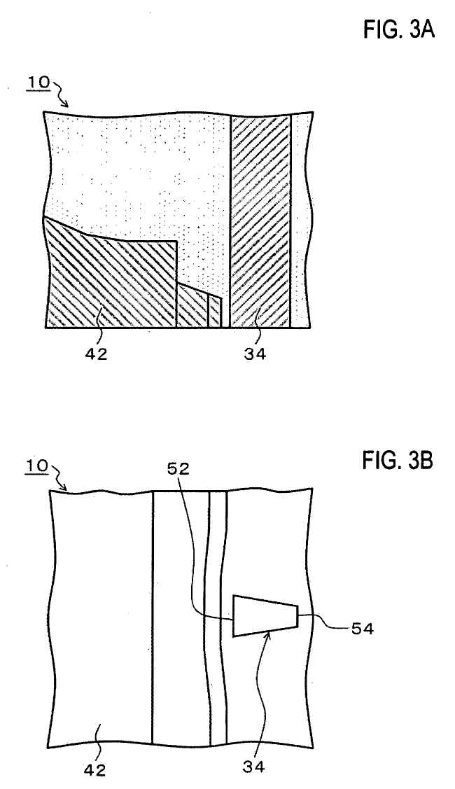

FIG. 3A is an enlarged view of the core portion of the main magnetic pole of FIG. 1A. FIG. 3B is an enlarged view of the core portion of the main magnetic pole of FIG. 1B. FIG. 3A is a cross sectional view. FIG. 3B is an end view of the opposing face of the medium 10-1 viewed from the recording medium. As seen in FIG. 3A and FIG. 3B, the end surface of the core of the main magnetic pole 34 exposed to the opposing face of the medium 10-1 of the head 10 is constructed with a wider width on the trailing edge 52 side and narrower width on the leading edge 54 side.

The perpendicular magnetic recording head 14 of the embodiment shown in FIG. 1A, FIG. 1B, FIG. 2, FIG. 3A, and FIG. 3B is an example of a head equipped with a trailing shield known as a common standard head. In other words, the trailing shield 42 adjacent to the trailing edge of a main magnetic pole is provided as a magnetic shield layer to a magnetic monopole head including the main magnetic pole, a write coil, and a return yoke.

In a normal magnetic monopole head, the magnetic flux generated from the main magnetic pole 34 pass through the soft magnetic underlayer 20 which is a soft magnetic material and returns to the return yoke in the perpendicular magnetic recording medium 16. The flux form a closed magnetic circuit. Recording onto the recording layer 18 of this perpendicular magnetic recording medium 16 is performed by a magnetic field generated from the trailing edge 52 of the main magnetic pole 34 shown in FIG. 3B.

In contrast, in a magnetic monopole head equipped with a trailing shield as shown in the present embodiment, one part of the recording magnetic field generated from the trailing edge 52 of the main magnetic pole 34 is absorbed by the trailing shield 42. This absorption makes it possible to steepen the magnetic field distribution and increase the slope of the magnetic field. As a result, a magnetic transition of a sharp medium is obtained allowing high-density recording.

Additionally, the recording magnetic field forms a combined magnetic field between the magnetic field in the perpendicular direction and the magnetic field in the horizontal direction due to the trailing shield 42. Namely, the recording magnetic field slopes from the perpendicular direction in the diagonal direction. By reducing the perpendicular magnetic component in this manner it is possible to effectively increase the switching magnetic field that reverses the magnetic medium.

The dimensions of the core 50 provided on the end of the main magnetic pole 34 shown in FIG. 2 must be controlled to a high precision in this type of magnetic monopole head equipped with a trailing shield that allows high-density recording and an effective increase in the magnetic medium of an inverted switching magnetic field.

Therefore, the manufacturing method of the main magnetic pole 34 of the embodiment needs a scanning electron microscope (SEM) to measure the core width in steps that allows the main magnetic pole 34 to be manufactured and verify that the core width is within the allowable error range.

It must be possible to accurately measure the core width by observations using a scanning electron microscope during the manufacturing of the main magnetic pole of this perpendicular magnetic recording head. In this embodiment, an inorganic insulating layer forms on both sides of the plating layer that comprises the main magnetic pole patterned in the manufacturing step of the main magnetic pole. The core width can be accurately measured by using a scanning electron microscope to measure the gap of this inorganic insulating layer.

In the manufacturing of the main magnetic pole 34 of FIG. 1A and FIG. 1B, a stop layer is formed through the inorganic insulating layer on both sides of the main magnetic pole comprised by the patterned plating layer in the widthwise direction.

In this embodiment, the inorganic insulating layer is arranged between the main magnetic pole comprised by the plating layer and the stop layer. Compared to when directly forming the stop layer on the outside of the plating layer of the main magnetic pole, the inorganic insulating layer formed on both sides of the main magnetic pole clearly appears while measuring the core width observed by a scanning electron microscope when the forming of the main magnetic pole is completed. The core width of the main magnetic pole can be accurately measured by measuring the length of the gap of the inorganic insulating layer.

Either SiO₂, Al₂O₃ or a diamond-like carbon (DLC) are used as the inorganic insulating layer that forms on both sides of the main magnetic pole comprised by the plating layer.

The manufacturing method of the main magnetic pole whose core width can be measured at a high precision in this embodiment basically includes the following steps.

(1) Forming a stop layer through a first inorganic insulating layer on a main magnetic pole patterned on a substrate.

(2) Forming a second inorganic insulating layer on the main magnetic pole, the first inorganic insulating layer, and the stop layer.

(3) Flattening the second inorganic insulating layer to use the stop layer as a stop material.

(4) Removing the stop layer.

(5) Flattening the first inorganic insulating layer and the main magnetic pole.

After these steps are complete, the core width of the main magnetic pole is measured by a scanning electron microscope (SEM).

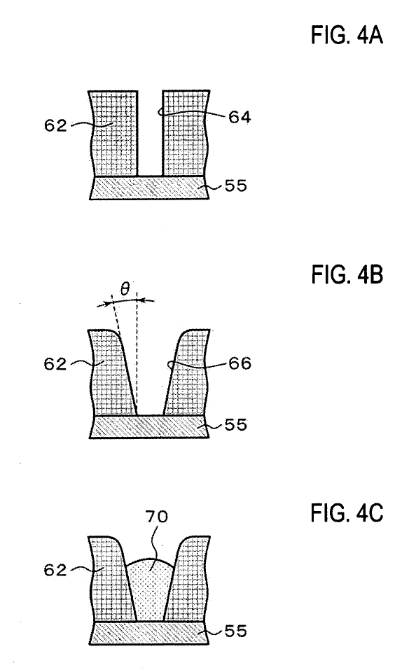

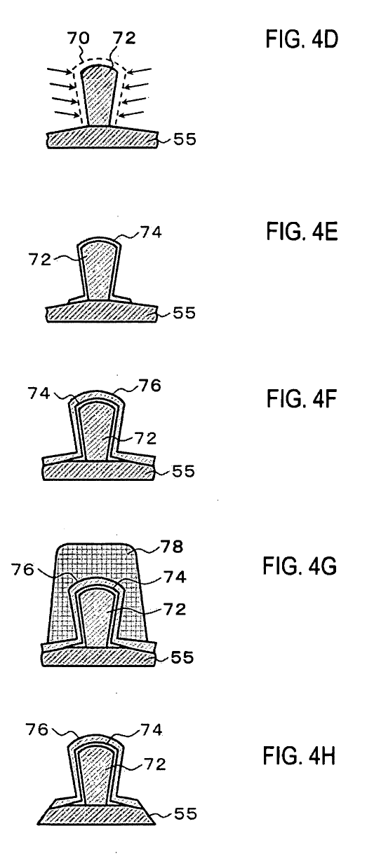

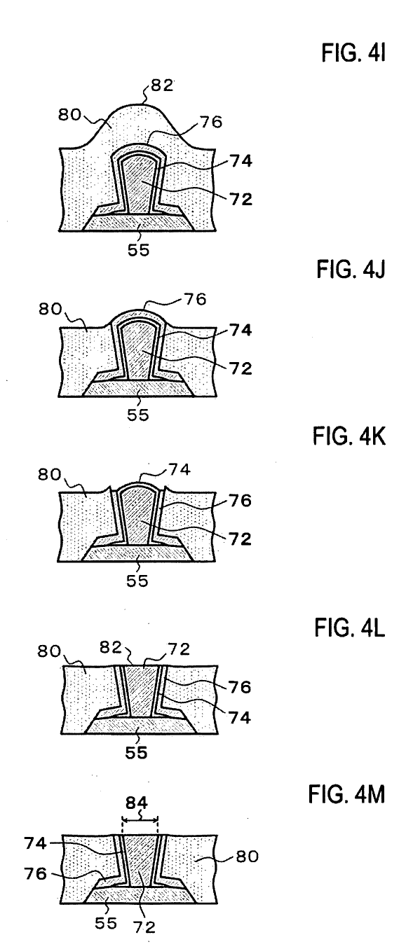

Next, the manufacturing method of the magnetic recording head having the structure of the main magnetic pole in this type of embodiment will be described referring to FIG. 4A to FIG. 4M.

FIG. 4A is the first manufacturing step of the perpendicular magnetic recording head 14 that is performed following the completion of the manufacturing step of the read head 12 shown in FIG. 1A and FIG. 1B. A resist 62 is formed on the plating base 55 (substrate). The resist 62 is exposed and developed to make a channel for forming the plating of the main magnetic pole 34.

FIG. 4A shows the end of the core 50 in FIG. 2, viewed from the side of the opposing face of the medium 10-1.

Next, the resist 62 is heated to a specified temperature by a post bake, a channel 64 of FIG. 4A is modified to form a tapered channel 66, and then rounded at its upper an edge. The width of the leading edge 54 of the main magnetic pole 34 shown in FIG. 3B is determined by the width of the channel 64 of FIG. 4A. Consequently, the width of the trailing edge 52 is determined by taper angle θ in FIG. 4B. For example, the heating temperature and time of the post bake is controlled such that θ=10 degrees.

Next, in the step shown in FIG. 4C a selective electrolytic plating method is used to form the plating layer 70 (CoFe) as the main magnetic pole.

Thereafter, in the step shown in FIG. 4D the resist 62 that forms the plating layer 70 of FIG. 4C is ion milled. The ion milling is performed from a diagonal direction using Ar ions. Removing the resist and milling of the plating layer 70 forms the main magnetic pole 72.

Next, in the step shown in FIG. 4E a first inorganic insulating layer 74 is formed on the outside of the main magnetic pole 72. Aluminum sputtering is performed to form an Al2O3 layer as the first inorganic insulating layer. This step, in which the first inorganic insulating layer 74 (the Al2O3 layer formed by this aluminum sputtering) is formed, is newly added in the embodiment. Forming the first inorganic insulating layer 74 makes it possible to improve the measurement accuracy of the core width when the manufacturing step of the main magnetic pole is completed.

Next, as shown in the step in FIG. 4F, Ta is sputtered to form a Ta cap layer as the stop layer 76 on the outside of the first inorganic insulating layer 74.

Next, as shown in the step in FIG. 4G, a resist 78 is patterned to cover the main magnetic pole 72.

Next, as shown in the step in FIG. 4H, by ion milling the resist 78, the resist 78 and the plating base 55 around the main magnetic pole 72 is removed simultaneously.

Next, as shown in the step in FIG. 4I, aluminum overcoating is performed to form an Al₂O₃ layer as a second inorganic insulating layer 80 covering the entire outside of the stop layer 76 by which the main magnetic pole 72 is covered.

Next, as shown in the step in FIG. 4J, chemical mechanical polishing (CMP) is used to flatten the second inorganic insulating layer 80 using stop layer 76 as a stop material. A protrusion 80-1 shown in FIG. 4I is removed.

Next, as shown in the step in FIG. 4K, reactive ion etching is used to remove the top of the stop layer (Ta) 76 flattened and exposed in FIG. 4J. This reactive ion etching uses CF₄ gas or the like as a reactive gas.

Next, as shown in the step in FIG. 4L, chemical mechanical polishing (CMP) is used to remove the curved portion of the top of the first inorganic insulating layer 74 formed on the outside of the main magnetic pole 72 of FIG. 4K. The manufacturing step of the main magnetic pole 72 is completed after this second CMP flattening.

Thereafter, as shown in FIG. 4M, the core width 84 is measured using a scanning electron microscope (SEM) for the top surface 82 of the flattened main magnetic pole 72.

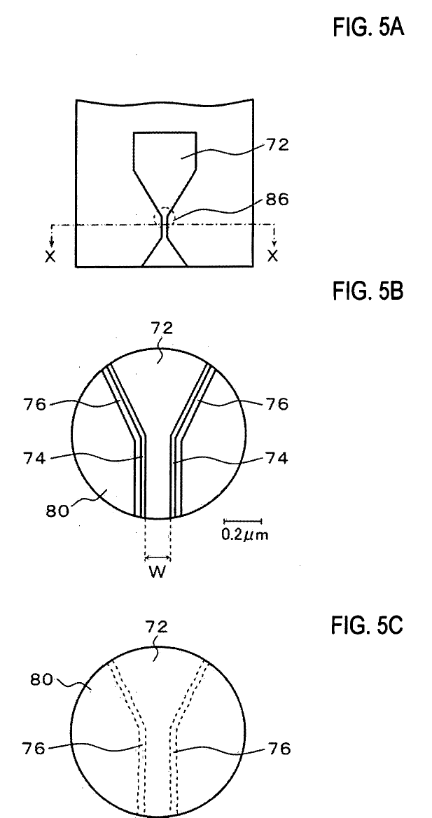

FIG. 5A to FIG. 5C show the main magnetic pole structure manufactured through the steps shown in FIG. 4A to FIG. 4L. The end of the main magnetic pole 72A is formed in a microscopic width. In this step, a scanning electron microscope (SEM) is used to observe and measure the core width of the core width 86.

FIG. 5B is an image observation of the core width 86 obtained by this embodiment according to a scanning electron microscope. FIG. 5C is an image observation in a conventional core structure.

The stop layer 76 is directly formed on both sides of the main magnetic pole 72 in the conventional structure of FIG. 5C. Because of this, it is very difficult to distinguish the boundary between the stop layer 76 and the plating layer of the main magnetic pole 72 as an observation image of a scanning electron microscope.

In contrast to this, in the structure of the embodiment of FIG. 5B, the first inorganic insulating layer 74 forms on both sides of the main magnetic pole 72 (a plating layer) and the stop layer 76 forms on the outside of the first inorganic insulating layer 74. Therefore, the boundary between the plating layer of the main magnetic pole 72 and the stop layer 76 clearly appears by the inorganic insulating layer 74, making it possible to accurately measure the core width W.

Here, the core width W required by the head of the embodiment is, for example, a design dimension of W=150 nm. The allowable error range of the core width achieved in an actual head is, for example, ±10%. Items with a core width outside this allowable error range are removed as defective items.

In the embodiment the core width W is accurately measured by forming the stop layer 76 through the first inorganic insulating layer 74 on both sides of the main magnetic pole 72 (a plating layer). The items with core widths within allowable error range being mistakenly disposed of as defective items reduce manufacturing yield rates. Eliminating measurement errors makes it possible to reliably prevent reductions in manufacturing yield rates. Therefore, the accuracy of the exact dimensions of the core width W can be controlled during the manufacturing.

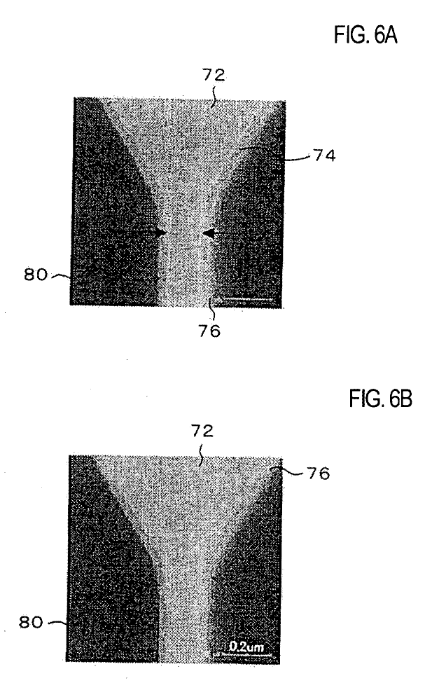

FIG. 6A and FIG. 6B show the main magnetic pole structure obtained by the manufacturing method of the embodiment and the main magnetic pole structure of a conventional example in comparison with a photographic image observation obtained by a scanning electron microscope (SEM). The first inorganic insulating layer 74 formed between the main magnetic pole 72 and the stop layer 76 clearly appears as an observed image in the main magnetic pole structure of the present invention of FIG. 6A. Since the core width can be measured as a width on the inside of the first inorganic insulating layer 74, the core width can be accurately measured.

In contrast to this, in the conventional example shown in FIG. 6B, the stop layer 76 is directly formed on the outside of the main magnetic pole 72 without the first inorganic insulating layer 74. This boundary area is very unclear in the observed image and it is apparent that errors will occur while measuring the core width.

When the core width 84 in the main magnetic pole structure of FIG. 5A is verified to be within the allowable error dimension, the opposing face of the medium is formed by removing the lower side at line X-X (flattening the X-X plane thereof).

After this type of main magnetic pole structure of the embodiment is manufactured, the structure on the trailing edge side shown in FIG. 1A and FIG. 1B will be manufactured by a semiconductor technology. As shown in FIG. 1A and FIG. 1B, the head 10 which has the read head 12 and the trailing shield type perpendicular magnetic recording head 14 is manufactured.

The embodiment described above is an example of a perpendicular magnetic recording head that has a magnetic monopole structure equipped with trailing shields. However, the present invention can also be applied without modifications to an ordinary magnetic monopole-structure perpendicular magnetic recording head that is not equipped with trailing shields, namely a standard magnetic monopole head.

Additionally, CoFe is used as the main magnetic pole in the above embodiment. However, the embodiment is not limited to this and other materials with strong magnetic properties, such as CoNiFe, can also be used.

In addition, NiFe is also used in the main magnetic pole auxiliary layers, in return yoke, and in shielding layers in the above embodiment. The embodiment is not limited to this and other materials with strong magnetic properties, such as CoNiFe, can also be used.

Furthermore, an Al₂O₃ layer is formed as the insulating layer in the above embodiment. However, a chemically stable insulating material other than this, such as SiO₂, can also be used, too.

Electrolytic plating is used as the method to form the main magnetic pole in the above embodiment. However, the embodiment is not limited to electrolytic plating and a sputtering method can also be used.

Ion milling is used for the slimming involved with the resist removal of the main magnetic pole in the above embodiment. However, the embodiment is not limited to this and reactive ion etching can also be used.

The present invention is not limited to the conditions as set forth in the embodiment described above and various modifications are possible as long as they do not lose the objective and scope of the invention. Furthermore, the present invention is not limited to the numerical values shown in the embodiment described above.

According to the present invention, a stop layer is formed, through an inorganic insulating layer made of a material such as SiO₂, Al₂O₃, or diamond-like carbon, on both sides of the core width in the widthwise direction on the main magnetic pole. The boundary between the main magnetic pole and the metal layer becomes clear by the intervention of the inorganic insulating layer when viewing the flattened pattern plane by a scanning electron microscope and measuring the width of the main magnetic pole as a core width. Therefore, the measurement accuracy of the main magnetic pole width can be improved and reductions in manufacturing yield rates which occur due to measurement errors can be prevented.

What is claimed is:

1. A magnetic recording head comprising:
a main magnetic pole made of at least a magnetic material; and
a coil,
wherein said main magnetic pole has a stop layer through an inorganic insulating layer on both sides of said main magnetic pole in the widthwise direction.

2. The magnetic recording head according to claim 1, wherein said inorganic insulating layer is SiO₂, Al₂O₃, or a diamond-like carbon.

3. A manufacturing method of a magnetic recording head comprising steps of:
forming a stop layer through a first inorganic insulating layer on a main magnetic pole patterned on a substrate;
forming a second inorganic insulating layer on said main magnetic pole, said first inorganic insulating layer, and said stop layer;
flattening said second inorganic insulating layer using said stop layer as a stop material;
removing said stop layer; and
flattening said first inorganic insulating layer and said main magnetic pole.

4. The manufacturing method of a magnetic recording head according to claim 3, wherein said first inorganic insulating layer is SiO₂, Al₂O₃, or a diamond-like carbon.

5. The manufacturing method of a magnetic recording head according to claim 3, wherein said second inorganic insulating layer is Al₂O₃.

6. The manufacturing method of a magnetic recording head according to claim 4, wherein said second inorganic insulating layer is Al₂O₃.

7. The manufacturing method of a magnetic recording head according to claim 3, wherein said flattening is performed by chemical mechanical planarization.

8. The manufacturing method of a magnetic recording head according to claim 4, wherein said flattening is performed by chemical mechanical planarization.

9. The manufacturing method of a magnetic recording head according to claim 5, wherein said flattening is performed by chemical mechanical planarization.

10. The manufacturing method of a magnetic recording head according to claim 6, wherein said flattening is performed by chemical mechanical planarization.

11. The manufacturing method of a magnetic recording head according to claim 3, wherein removal of said stop layer is performed by reactive ion etching.

12. The manufacturing method of a magnetic recording head according to claim 4, wherein removal of said stop layer is performed by reactive ion etching.

13. The manufacturing method of a magnetic recording head according to claim 5, wherein removal of said stop layer is performed by reactive ion etching.

14. The manufacturing method of a magnetic recording head according to claim 6, wherein removal of said stop layer is performed by reactive ion etching.

15. A method for measuring plating width comprising steps of:
forming inorganic insulating layers on both sides of a patterned plating layer; and
measuring the gap between said inorganic insulating layers.

16. The method for measuring plating width according to claim 14, wherein said plating layer is a main magnetic pole of a magnetic recording head.

17. The method for measuring plating width according to claim 14, wherein said inorganic insulating layer is SiO₂, Al₂O₃, or a diamond-like carbon.
